(19) United States
(12) Patent Application Publication
(10) Pub. No.: US 2002/0062704 A1
(43) Pub. Date: May 30, 2002

(54) Quiet driveline assembly and method for producing the same

(76) Inventors: Adrian Ungvari, Beverly Hills, MI (US); Binod K. Agrawal, Rochester Hills, MI (US); Sachin M. Harwalkar, Farmington Hills, MI (US)

Correspondence Address: Steven L. Oberholtzer, BRINKS HOFER GILSON & LIONE, P.O. Box 10395, Chicago, IL, 60610, US

(21) Appl. No.: 10/055,234

(22) Filed: Oct. 25, 2001

Related U.S. Application Data
(60) Provisional application No. 60/243,829, filed on Oct. 27, 2000.

(51) Int. Cl. F16C 3/00; F16H 1/12

(52) U.S. Cl. 74/423; 464/180; 74/424

(57) ABSTRACT

The quiet drive of this invention provides for drive align imbalance and resulting drive align vibration and noise perceived by the vehicle occupants is overcome. The invention reduces imbalance in the system by establishing a theoretical center cylinder for the entire driveline components from the transmission or the transfer case if appropriate to the axle. Upon this theoretical centerline, each component is measured and controlled through unique design, machining and tolerancing to achieve an optimal minimum of driveline imbalance and resulting driveline vibration and noise perceived by the vehicle occupants.

### CROSS-REFERENCE TO OTHER APPLICATIONS

The application on this invention relates to U.S. Provisional Application Serial No. 60/243,829, filed Oct. 27, 2000 and entitled “Quiet Driveline System And Method For Producing The Same”.

### BACKGROUND AND SUMMARY OF THE INVENTION

The present invention relates to a quiet driveline system for use in an automobile and a method for making the same. This invention is advantageously useable on rear wheel drive, fourth wheel drive and all wheel drive automobiles in which a driveshaft is paired to an axle, a transmission or a transfer case. This application is based on U.S. Provisional Serial No. 60/243,829 filed Oct. 27, 2000, entitled “A Quiet Driveline System and Method for Producing the Same”.

In conventional automobile driveline systems, a driveshaft flange is bolted to an axle flange, in order to transfer torque from either the transmission or the transfer case to the driveshaft or from the driveshaft to the axle. The transmission, transfer case, axle and driveshaft flanges rotated through a range of high speeds during the operation of the automobile.

If the center of gravity varies significantly from the rotational centerline of the rotating components, imbalances are introduced into the driveline system, which cause objectionable noise to the vehicle occupants. By ensuring that the centers of gravity of the various elements are substantially co-linear with each other and with the centerline of the driveline system, imbalance and the resulting objectionable noise is reduced.

Conventional automobile drive train flanges such as those provided for attachment with a universal or constant velocity joint are typically cast or forged with a center hole for later machining. The centerline of the cast or forged hole defines the centerline of that particular part without regard to the center of gravity. Later machining operations bore the diameter larger or form machine screw threads to the inner surface of this cast or forged hole to allow the part to be attached to the other components in the driveline system.

Similarly, cast and forged axle and transfer case pinions are machined without regard to imbalances in the pinion shaft due to imperfections on surfaces that are not machined and due to other sources of imbalance. These surfaces can include spaces between the bearing mounting surfaces and the pilot shaft for aligning the pinion with the driveshaft flange. Concurrently, transmission output shafts and their companion driveshaft slip joints are also produced without regard to imbalances caused by uneven surfaces that are not required to be machined for functional reasons.

Each different component in the driveline system is produced without regard to its own imbalance and without regard to the imbalance of the overall collection of parts. Parts are then assembled into a driveline system with a resultant system imbalance made up of each of the individual imbalances. Not only does this result in system imbalances, but it also results in widely varying imbalance characteristics from vehicle to vehicle.

This invention reduces imbalance in the system by establishing a theoretical center cylinder for the entire driveline assembly, from the transmission or transfer case if appropriate to the axle. The center cylinder defines a volume within which the center of gravity of the part is located. This diameter reflects a design decision of acceptable levels of imbalance. This center cylinder is designated by balance radii that extend from the discrete centerlines of the transmission output shaft, the transfer case, the driveshaft, and the axle. Upon this theoretical centerline all imbalances are measured and controlled through unique design, machining and tolerancing to achieve an optimal minimum driveline imbalance and resulting driveline vibration and noise perceived by the vehicle occupants.

Conventionally, holes are drilled and/or surfaces are machined in response to the requirements for center of gravity tolerancing. This optimal minimum varies, depending on many variables including the materials used in the driveline and the vehicle, the driveline design, the vehicle design, the vehicle, the intended customers sensitivity to noise, and the money that the automobile manufacturer is willing to spend to reduce noise in the particular vehicle. By controlling features and surfaces so as to keep the center of gravity of all rotating components within a driveline center cylinder volume, the invention develops a system that reduces and controls imbalance. This center cylinder is defined by imbalance radii that reduce the imbalance to an optimal minimum.

Other general and more specific aspects of this invention will be set forth in the ensuing description and claims.

### BRIEF DESCRIPTION OF THE DRAWINGS

The drawings that will now be described are incorporated herein to illustrate a preferred embodiment of the invention and a best mode presently contemplated for carrying out the invention.

FIG. 1 shows a sectional view of an axle along with the driveshaft flange; and shows the relationship of a pinion, a pinion nut, an axle flange, and driveshaft flange and other axle components;

FIG. 2 is a sectional view of a pinion shaft and showing the difference between the balance radii;

FIG. 3 is a sectional view of an axle flange and showing the difference between the balance radii;

FIG. 4 is a sectional view of a pinion nut, and showing the difference between the balance radii; and

FIG. 5 showing the gap between the geometric centerline and the axis of gravity (cg).

### DETAILED DESCRIPTION OF THE INVENTION

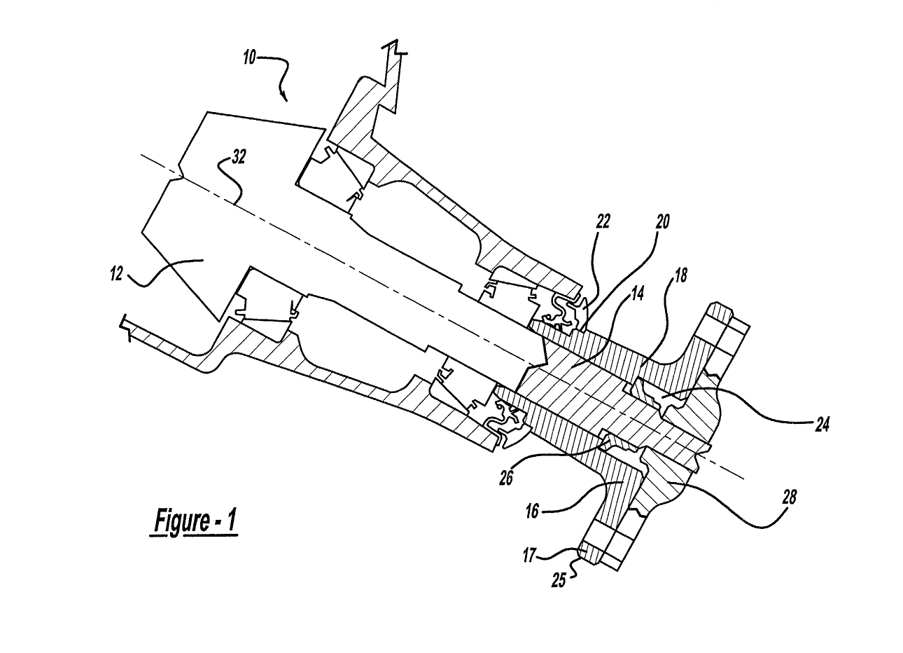

With respect to the drawings, the quiet driveline is shown at FIG. 1 and is designated numeral 10. The driveline 10 consists of a differential pinion 12 that is integral with the pinion shaft 14. The pinion shaft 14 is supported in the axle flange 16 which has an elongated tubular portion 18, which extends lengthwise of the pinion shaft 14 and at its upper end 20 it is contacted by a seal 22.

The axle flange 16 has a foot portion 17 annular in shape and enlarging to provide an open space 24 for the pinion nut 26.

A driveshaft flange 28 is coaxially supported on the pinion shaft 14 in line with the axle flange 16. Both the axle flange 16 and driveshaft flange 28 are aligned and parallel with the geometric centerline 32 for the shaft 14.

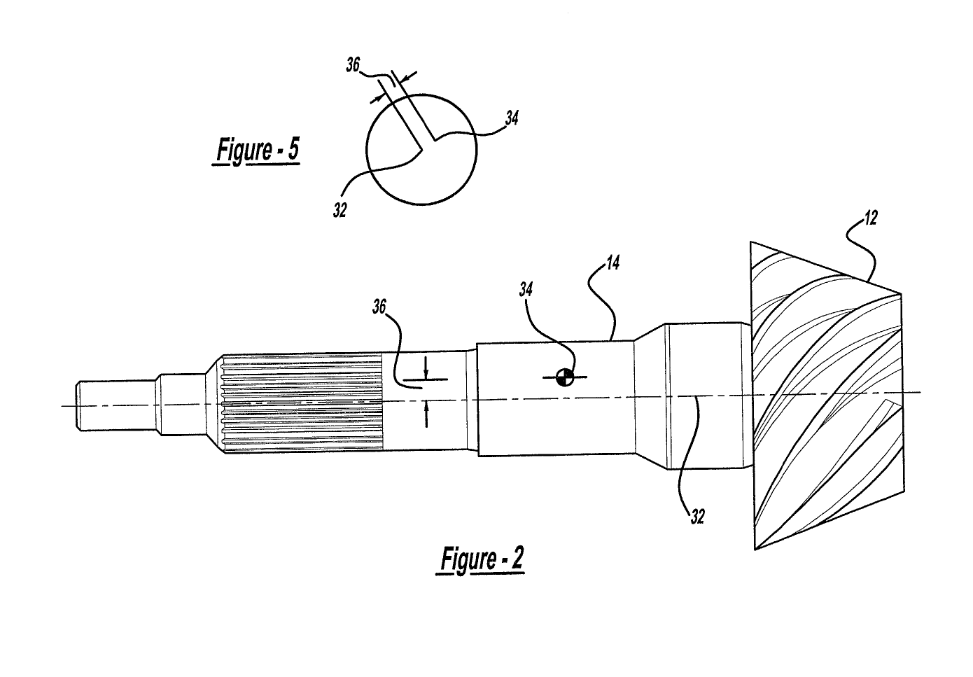

The axis of center of gravity of the pinion shaft 14 is shown as 34 (FIG. 2). The radial offset of the axis of gravity relative to the geometric centerline is shown at 36 in FIGS. 2 and 5.

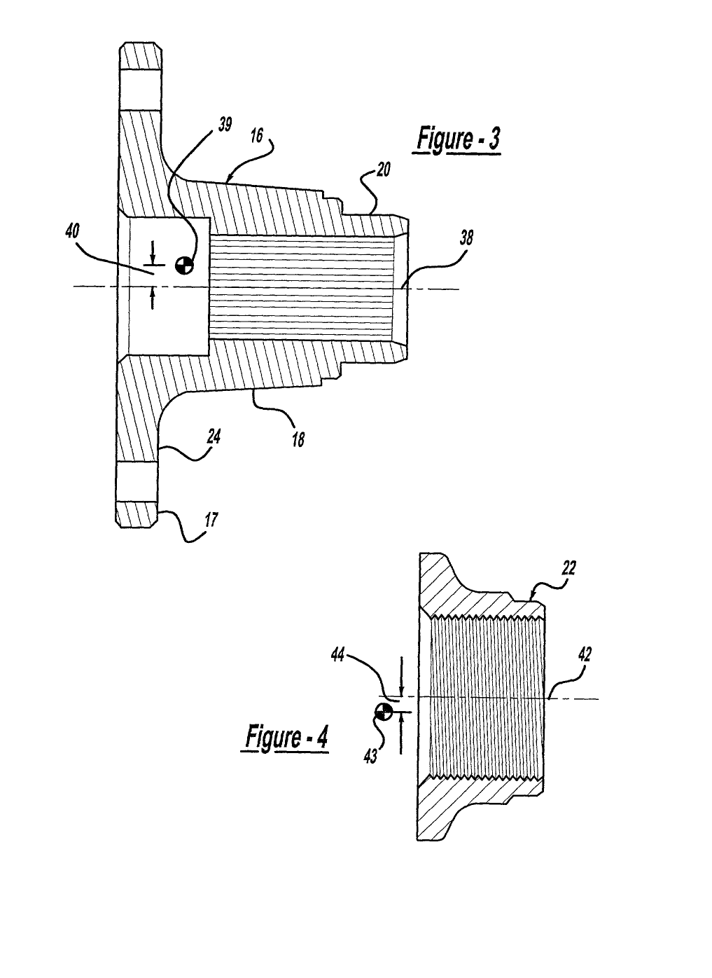

The axle flange 16 is shown in FIG. 3 as having the tubular portion 18 for supporting the pinion shaft 14 and foot portion 17. The geometric center of the axle flange 16 is shown at geometric center 38 and the radial offset from its center of gravity location 39 is shown at 40 spaced from the geometric center 38.

The pinion nut 26 is shown in FIG. 4 as having a geometric center 42 and a radial offset 44 from its center of gravity 43.

In accordance with this invention each of the components described previously including pinion shaft 14, axle flange 16, and pinion nut 26 are evaluated to determine the location of their center of gravity, 34, 39, and 43, respectively. Tolerances are established for each part to define an allowable cylinder for that component centered about its geometric centerline within which the center of gravity must be located. The driveshaft flange 28 can also be added to the list of components, pinion shaft 14, axle flange 16, and pinion nut 26 to complete the invention.

If the parts do not exhibit a radial offset between its geometric center and center of gravity within allowable tolerances it is processed further to adjust its center of gravity location. The diameter of the allowable center of gravity location cylinder for each part is selected so that when they are assembled together the resultant center of gravity location will be within an acceptable deviation from the rotational axis 32 of the overall assembly.

As a result the invention reduces imbalance in the system by establishing a theoretical center cylinder for the entire driveline system from the transmission or transfer case to the axle. This center cylinder is defined by balance radii that extend from the discrete centerlines of the transmission output shaft, the transfer case, the driveshaft and the axle. Upon these theoretical centerlines all imbalances are measured and controlled through unique design, machining and tolerancing to achieve an optimal minimum of driveline imbalance and resulting driveline vibration and noise perceived by the vehicle occupants. Holes are drilled and surfaces are machined in response to the requirements for center of gravity tolerancing. This optimal minimum varies depending on many variables including the materials used in the driveline and the vehicle, the driveline design, the vehicle design, the vehicle, the intended customer's sensitivity to noise and the money that the automobile manufacturer is willing to spend to reduce noise in the particular vehicle by controlling these features and surfaces so as to keep the center of gravity of all rotating cap components within a driveline centerline cylinder volume. The invention develops a system that reduces and controls imbalances.

The foregoing discussion discloses and describes preferred embodiments of the invention. One skilled in the art will readily recognize from such discussion, and from the accompanying drawings and claims, that changes and modifications can be made to the invention without departing from the true spirit and fair scope of the invention as defined in the following claims. The invention has been described in an illustrative manner, and it is to be understood that the terminology that has been used is intended to be in the nature of words of description rather than of limitation.

We claim:

1. A quiet driveline for an automotive vehicle comprising:
a driveshaft comprising a shaft and rear driveshaft flange,
an axle, operatively connected to said driveshaft flange by an axle flange, said axle further comprising a pinion and a pinion nut, and
a driveline center cylinder defined by balance radii about the centerline of said driveshaft and said axle, said driveline center volume defining a volume within which the centers of gravity of said transmission output shaft and any rotating component of said driveshaft and said axle reside, wherein said balance radius is of a value so as to reduce driveline vibration to an optimal minimum.

2. A method for producing a quiet driveline for an automobile comprising the steps of:
providing at least one rotating component of a driveline to have an imbalance tolerance, one rotating component and the rotating axis of said at least one rotating component,
defining a driveline center volume which defines a volume about the center line of a driveshaft and an axle, said driveline center volume representing a volume within which said imbalance standard, wherein said at least one optimal minimum imbalance standard to optimally reduce vibration.

3. A quiet driveline for an automotive vehicle comprising:
a driveshaft comprising a pinion shaft and rear driveshaft flange,
a pinion nut, operatively connected to said driveshaft flange by an axle flange,
a driveline center cylinder defined by balance radii about the centerline of said driveshaft and said pinion shaft, said driveline center volume defining a volume within which the centers of gravity of said transmission output shaft and any rotating component of said driveshaft and said axle reside, wherein said balance radius is of a value so as to reduce driveline vibration to an optimal minimum.
